(19) United States
(12) Patent Application Publication
(10) Pub. No.: US 2026/0121473 A1
(43) Pub. Date: Apr. 30, 2026

(54) ELECTRIC MOTOR

(71) Applicant: MITSUBISHI ELECTRIC CORPORATION, Tokyo (JP)

(72) Inventors: Jun HOSONO, Tokyo (JP); Yuichiro NAKAMURA, Tokyo (JP); Saku MORIMOTO, Tokyo (JP); Kenta MOTOYOSHI, Tokyo (JP); Takaya OHIRA, Tokyo (JP)

(73) Assignee: MITSUBISHI ELECTRIC CORPORATION, Tokyo (JP)

(21) Appl. No.: 19/489,616

(22) PCT Filed: Jul. 19, 2023
(86) PCT No.: PCT/JP2023/026448

§ 371 Date: Dec. 3, 2025

(51) Int. Cl. H02K 3/26; H02K 9/00

(52) U.S. Cl. CPC H02K 3/26; H02K 9/00

(57) ABSTRACT

An electric motor includes an armature including a printed circuit board having a cylindrical shape, the printed circuit board forming a plurality of layers stacked in a radial direction of the cylindrical shape; and a field system disposed toward a central axis of the cylindrical shape with respect to the armature. The printed circuit board includes a plurality of coils arranged in a circumferential direction of the cylindrical shape. Each of the plurality of coils is formed from a linear conductor. Assuming that the conductor on the printed circuit board has a width denoted by x and a thickness in the radial direction denoted by y, the x and the y are respectively set to xₒₚₜ and yₒₚₜ that, in combination, maximize a space factor of the conductors in a cross section of the armature that is perpendicular to the circumferential direction.

### FIELD

The present disclosure relates to an electric motor in which a printed circuit board is used for an armature.

### BACKGROUND

A conventional electric motor is known to include a cylindrical printed circuit board for use in the armature. Patent Literature 1 discloses an electric motor in which a printed circuit board rolled into a cylindrical shape is used for an armature, and a plurality of coils are formed as conductor patterns on the printed circuit board.

### CITATION LIST

### Patent Literature

Patent Literature 1: Japanese Patent Application Laid-open No. 2020-89207

### SUMMARY OF INVENTION

### Problem to be Solved by the Invention

It is known that an armature using a printed circuit board rolled into a cylindrical shape tends to have a smaller coil space factor than an armature that includes an iron core and magnet wires wound around the iron core. As the coil space factor decreases, copper loss increases. Therefore, temperature rise caused by heat generation due to copper loss is a problem in an electric motor using the printed circuit board for its armature.

The present disclosure has been made in view of the above, and an object of the present disclosure is to obtain an electric motor capable of reducing heat generation from copper loss.

### Means to Solve the Problem

In order to solve the above-mentioned problem and achieve the object, an electric motor according to the present disclosure includes an armature including a printed circuit board having a cylindrical shape, the printed circuit board forming a plurality of layers stacked in a radial direction of the cylindrical shape; and a field system disposed toward a central axis of the cylindrical shape with respect to the armature. The printed circuit board includes a plurality of coils arranged in a circumferential direction of the cylindrical shape. Each of the plurality of coils is formed from a linear conductor. Assuming that the conductor on the printed circuit board has a width denoted by x and a thickness in the radial direction denoted by y, the x and the y are respectively set to xₒₚₜ and yₒₚₜ that, in combination, maximize a space factor of the conductors in a cross section of the armature that is perpendicular to the circumferential direction.

### Effects of the Invention

The electric motor according to the present disclosure has an effect of reducing heat generation from copper loss.

### BRIEF DESCRIPTION OF DRAWINGS

FIG. 1 is a diagram illustrating a schematic configuration of an electric motor according to a first embodiment.

FIG. 2 is an exploded view of the electric motor according to the first embodiment.

FIG. 3 is a diagram illustrating a printed circuit board included in an armature according to the first embodiment.

FIG. 4 is a diagram illustrating a portion of a coil included in the armature according to the first embodiment.

FIG. 5 is a sectional view of the armature according to the first embodiment.

FIG. 6 is a diagram illustrating a portion of the armature according to the first embodiment.

FIG. 7 is a diagram illustrating an exemplary process for manufacturing the armature according to the first embodiment.

FIG. 8 is a cross-sectional view of the electric motor according to the first embodiment.

FIG. 9 is a first diagram illustrating a slot count of the armature according to the first embodiment.

FIG. 10 is a second diagram illustrating the slot count of the armature according to the first embodiment.

FIG. 11 is a diagram illustrating an exemplary relationship between a conductor width and a space factor of conductors in a slot in the armature according to the first embodiment.

FIG. 12 is a cross-sectional view of the slot in the armature according to the first embodiment.

FIG. 13 is a diagram illustrating only cross sections of the conductors that are extracted from the cross section illustrated in FIG. 12.

FIG. 14 is a diagram illustrating a unit structure of the electric motor according to the first embodiment.

FIG. 15 is a sectional view of an armature according to a second embodiment.

FIG. 16 is a diagram illustrating a relationship between an arrangement of a coil in the armature according to the second embodiment and a winding factor.

FIG. 17 is a diagram illustrating an exemplary relationship between a width of an inner peripheral part of each coil and a copper loss coefficient in the electric motor according to the second embodiment.

FIG. 18 is a first diagram illustrating a configuration of an armature according to a third embodiment.

FIG. 19 is a second diagram illustrating a configuration of the armature according to the third embodiment.

FIG. 20 is a first diagram illustrating an arrangement of coils in the armature according to the third embodiment.

FIG. 21 is a second diagram illustrating an arrangement of the coils in the armature according to the third embodiment.

FIG. 22 is a third diagram illustrating the arrangement of the coils in the armature according to the third embodiment.

FIG. 23 is a fourth diagram illustrating the arrangement of the coils in the armature according to the third embodiment.

FIG. 24 is a fifth diagram illustrating the arrangement of the coils in the armature according to the third embodiment.

FIG. 25 is a sixth diagram illustrating a coil arrangement in the armature according to the third embodiment.

FIG. 26 is a cross-sectional view of a portion of an armature according to a fourth embodiment.

FIG. 27 is a cross-sectional view of a coil unit in the armature according to the fourth embodiment.

FIG. 28 is a cross-sectional view of a coil unit in an armature according to a fifth embodiment.

FIG. 29 is a schematic diagram of a printed circuit board included in an armature according to a sixth embodiment.

FIG. 30 is a schematic diagram of a printed circuit board included in an armature according to a seventh embodiment.

FIG. 31 is a diagram illustrating a schematic configuration of a printed circuit board included in an armature according to an eighth embodiment.

FIG. 32 is a cross-sectional view of a portion of the armature according to the eighth embodiment.

### DESCRIPTION OF EMBODIMENTS

With reference to the drawings, a detailed description is hereinafter provided of electric motors according to embodiments.

### First Embodiment

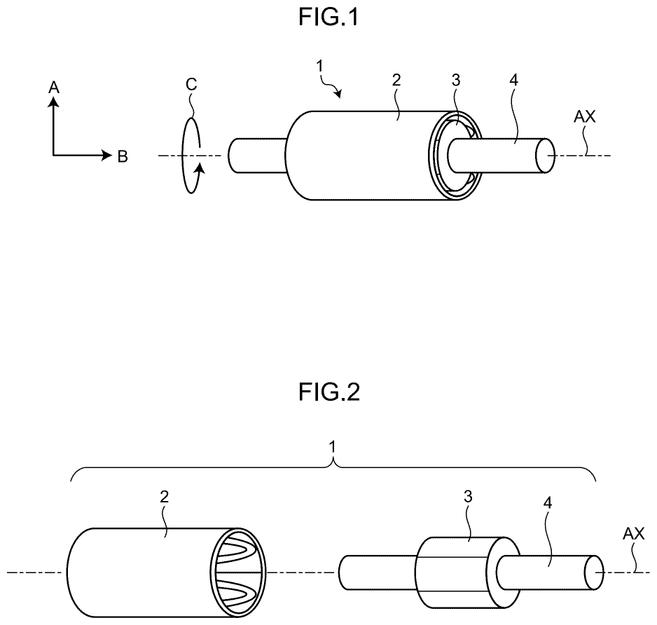

FIG. 1 is a diagram illustrating a schematic configuration of an electric motor 1 according to a first embodiment. FIG. 2 is an exploded view of the electric motor 1 according to the first embodiment. The electric motor 1 includes an armature 2 serving as a stator and a field system 3 serving as a rotor.

The armature 2 has a cylindrical shape. The field system 3 has a columnar shape. The field system 3 is disposed in a space surrounded by the armature 2. A central axis AX of the cylindrical armature 2 also serves as the central axis of the columnar field system 3. In other words, the armature 2 and the field system 3 are mutually coaxially disposed. The field system 3 is disposed toward the central axis AX with respect to the armature 2. The field system 3 rotates about the central axis AX. A shaft 4 is attached to the field system 3 to transmit power from the field system 3 to the outside of the electric motor 1.

The armature 2 generates a magnetic field through energization of its coils. The field system 3 is rotated by interaction between the magnetic field generated by the armature 2 and magnets of the field system 3. In the following description, a direction of the central axis AX is referred to as the axial direction, a direction perpendicular to the central axis AX is referred to as the radial direction, and a direction encircling the central axis AX is referred to as the circumferential direction. Arrows A, B, and C illustrated in FIG. 1 represent the radial direction, the axial direction, and the circumferential direction, respectively. The circumferential direction also refers to a rotational direction in which the field system 3 rotates.

While the electric motor 1 is described above as including the armature 2 as the stator and the field system 3 as the rotor, the electric motor 1 may include the armature 2 as the rotor and the field system 3 as the stator. When the armature 2 is the rotor, with the field system 3 being the stator, the field system 3 is mechanically locked by an electromagnetic brake or the like. The armature 2 is rotated by the interaction between the magnetic field generated by the armature 2 and the magnets of the field system 3. In FIGS. 1 and 2, magnetic gap faces of the armature 2 and the field system 3 are disposed radially inward; however, the magnetic gap faces of the armature 2 and the field system 3 may be disposed radially outward.

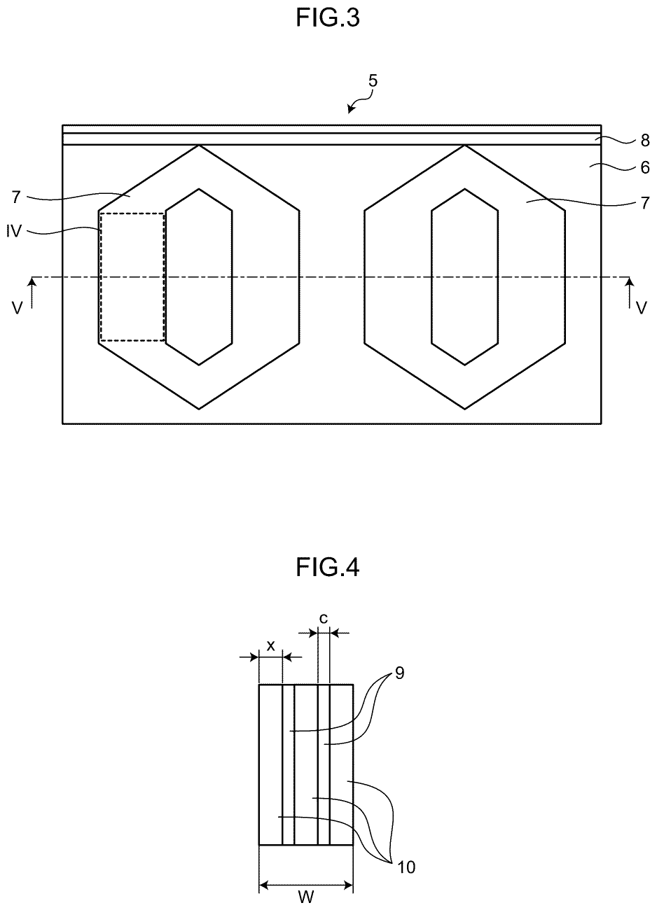

FIG. 3 is a diagram illustrating a printed circuit board 5 included in the armature 2 according to the first embodiment. The armature 2 includes the printed circuit board 5, which is rolled into a cylindrical shape. Because the printed circuit board 5 is rolled, a plurality of layers of the printed circuit board 5 are stacked in the radial direction of the armature 2. FIG. 3 is a plan view illustrating a state in which the coils 7 are provided on a surface of a core substrate 6. In FIG. 3, a left-right direction corresponds to the circumferential direction, and an up-down direction corresponds to the axial direction. When the cylindrical printed circuit board 5 is unrolled flat, the printed circuit board 5 assumes an elongated shape.

The printed circuit board 5 includes the core substrate 6, the plurality of coils 7 formed on the core substrate 6, and an insulating layer. FIG. 3 illustrates a portion of the printed circuit board 5 where two of the coils 7 are provided. A description of the insulating layer is provided later. When the printed circuit board 5 is unrolled flat, the plurality of coils 7 are arranged along a longitudinal direction of the printed circuit board 5. When the printed circuit board 5 is rolled into the cylindrical shape, the plurality of coils 7 are arranged in the circumferential direction.

In FIG. 3, the coils 7, which are adjacent to each other in the circumferential direction, are connected by crossover wiring 8. In the example illustrated in FIG. 3, the plurality of coils 7 in the armature 2 are arranged using a so-called concentrated winding method. The plurality of coils 7 in the armature 2 may be arranged using a so-called distributed winding method.

FIG. 4 is a diagram illustrating a portion of a coil 7 included in the armature 2 according to the first embodiment. FIG. 4 is an enlarged view of the portion from frame IV in FIG. 3. Each of the coils 7 is formed from a linear conductor 10. The conductor 10, which forms the coil 7, is spirally patterned on the core substrate 6. An empty space without the conductor 10 is provided at a center of the spiral. In the following description, the empty space, which is the central space of the coil 7, is referred to as the inner peripheral part. In the example illustrated in FIG. 3, the inner peripheral part is a hexagonal region. Starting from a point adjacent to the inner peripheral part, the conductor 10 is routed around the inner peripheral part a plurality of times. In the example illustrated in FIG. 3, the coil 7 has a hexagonal outer shape. The portion in frame IV is the portion of the coil 7 where the conductor 10 extends in the axial direction.

In the example illustrated in FIG. 4, the conductor 10 is routed around the inner peripheral part three times. FIG. 4 illustrates three parallel linear portions of the conductor 10. On the core substrate 6, a space 9 is provided between adjacent linear portions to provide insulation between the linear portions. It is to be noted that a planar configuration of the coil 7 is not limited to the configuration illustrated in FIGS. 3 and 4 and may be arbitrary. The coil 7 may have an outer shape other than a hexagon, such as an elliptical shape. The conductor 10 may be routed around the inner peripheral part more than three times.

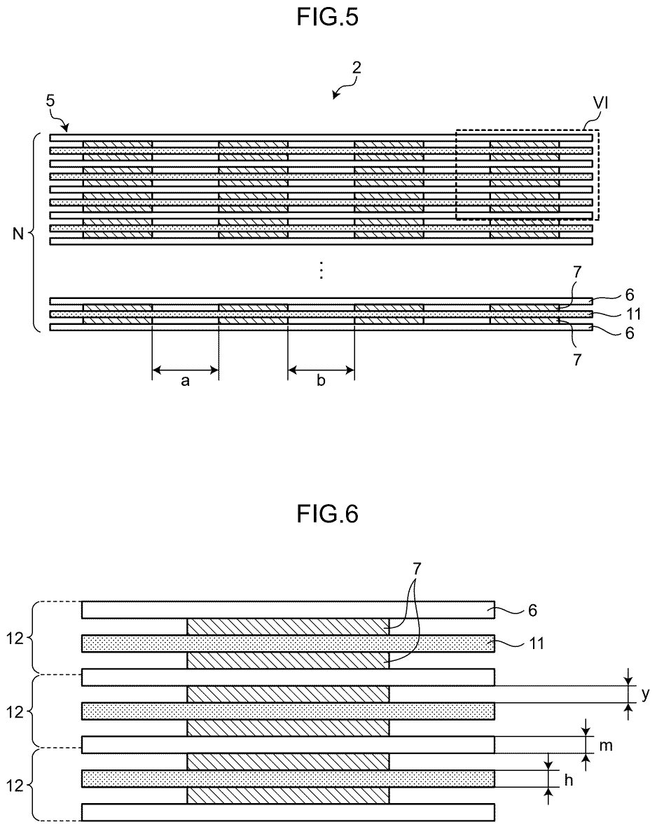

FIG. 5 is a sectional view of the armature 2 according to the first embodiment. The section illustrated in FIG. 5 is the section taken along line V-V in FIG. 3. FIG. 5 illustrates the cross section of the portion of the printed circuit board 5 rolled into the cylindrical shape. In FIG. 5, a left-right direction corresponds to the circumferential direction, and an up-down direction corresponds to the radial direction. FIG. 6 is a diagram illustrating a portion of the armature 2 according to the first embodiment. FIG. 6 is an enlarged view of the portion from frame VI in FIG. 5.

In the example illustrated in FIGS. 5 and 6, the coils 7 are provided on both faces of the core substrate 6. The printed circuit board 5 illustrated in FIGS. 5 and 6 corresponds to a so-called “double-sided mounting board”. The insulating layer 11 is provided between coils 7 aligned in the radial direction. The insulating layer 11 is, for example, an adhesive insulating sheet. The insulating layer 11 may be, for example, an adhesive sheet with insulating properties or an adhesive with insulating properties.

The armature 2 illustrated in FIGS. 5 and 6 has the plurality of stacked layers 12, each formed by sandwiching coils 7, the insulating layer 11, and coils 7 between two layers of the core substrate 6. The layers 12 of the printed circuit board 5, which are stacked in the radial direction, are N in number. N is a positive integer. In the following description, N is also referred to as the number of layers. In the example illustrated in FIG. 5, the core substrate 6 is present at both radial ends of the printed circuit board 5; however, the insulating layer 11 may be present at at least one of these ends.

While the printed circuit board 5 is described above as a “double-sided mounting board”, this is not limiting. The printed circuit board 5 may be a “single-sided mounting board” or a “multilayer mounting board”. When the printed circuit board 5 corresponds to a “single-sided mounting board”, the coils 7 are mounted on only one of the faces of the core substrate 6. When the printed circuit board 5 corresponds to a “multilayer mounting board”, the coils 7 are stacked on the core substrate 6, alternating with the insulating layer 11.

In the first embodiment, a portion of the conductor 10 that constitutes the coil 7 is formed with a uniform width on the printed circuit board 5. In the following description, the width of the conductor 10 on the printed circuit board 5 is denoted by x. The conductor 10 has a thickness of y in the radial direction. The portion of the coil 7 within frame IV illustrated in FIG. 3 has a width of W. The width of this portion of the coil 7 is the width in the circumferential direction. In the following description, W, which is the width of the portion of the coil 7, is also referred to as the slot width. The space 9 has a width of c in the circumferential direction. The width of the space 9 in the circumferential direction can also be said to be the spacing between the linear portions of the conductors 10 in the coil 7 on the printed circuit board 5. The core substrate 6 has a thickness of m in the radial direction, and the insulating layer 11 has a thickness of h in the radial direction. The inner peripheral part of each coil 7 has a width of a, and a distance between adjacent coils 7 is denoted by b. The width of the inner peripheral part is the width in the circumferential direction. The distance between the coils 7 is the distance in the circumferential direction.

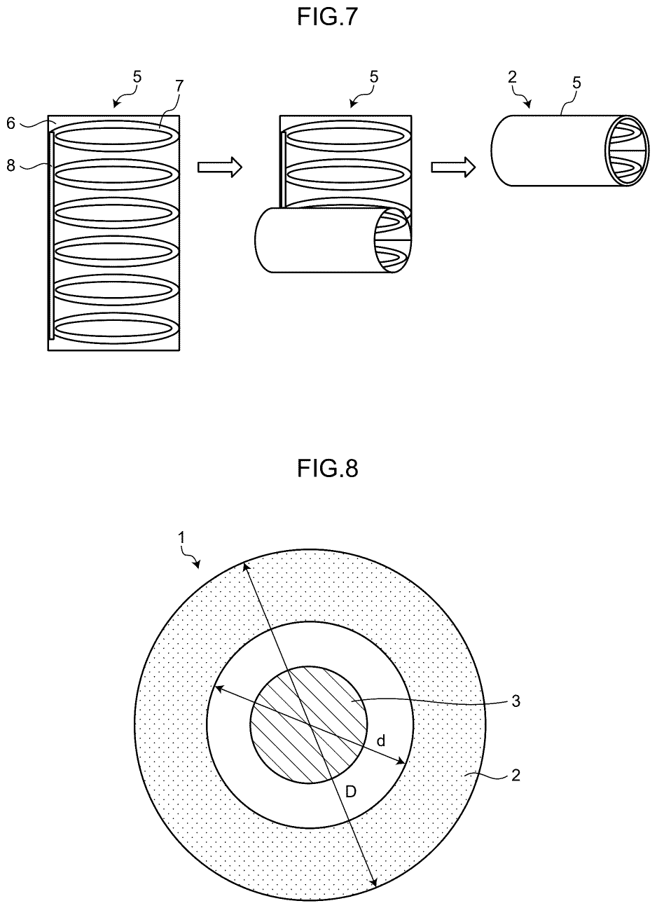

FIG. 7 is a diagram illustrating an exemplary process for manufacturing the armature 2 according to the first embodiment. FIG. 7 schematically illustrates how the armature 2, which includes the cylindrical printed circuit board 5, is formed by rolling the printed circuit board 5 from a flat, expanded state. Although either the core substrate 6 or the insulating layer 11 is present on an inner face of the cylindrical printed circuit board 5, the core substrate 6 or the insulating layer 11 on that face is omitted in FIG. 7. In the above description, the outer shape of the coil 7 is hexagonal; however, in FIG. 7, the outer shape of the coil 7 is simplified to an elliptical shape.

Each of the constituent elements of the printed circuit board 5 is required to be flexible enough not to break when the printed circuit board 5 is rolled. Furthermore, the constituent elements of the printed circuit board 5 are required not to exhibit significant changes in electrical characteristics, such as insulation performance, due to the rolling of the printed circuit board 5. The armature 2 is not limited to being formed by rolling the printed circuit board 5. The armature 2 may be one in which the coils 7 are mounted on a core substrate 6 that is preformed into a cylindrical shape.

FIG. 8 is a cross-sectional view of the electric motor 1 according to the first embodiment. The cross section illustrated in FIG. 8 is the section taken perpendicularly to the axial direction at a midpoint of the armature 2 in the axial direction. The armature 2 is described below as having an outside diameter of D and an inside diameter of d. Both D, which is the outside diameter, and d, which is the inside diameter, are diameters. Slots that are regions of the armature 2 where the coils 7 are arranged are n in number, and turns of the coils 7 are T in number per slot. The number of slots in the armature 2 is determined on the basis of specifications of the electric motor 1.

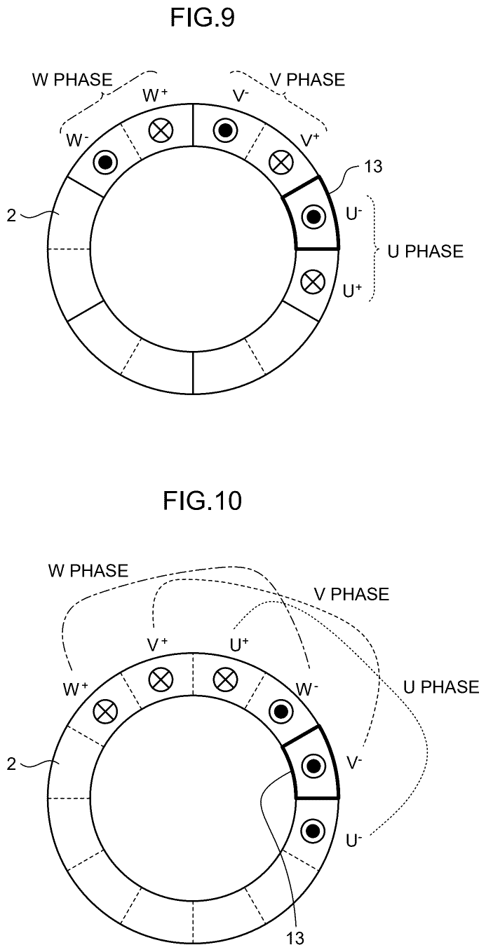

FIG. 9 is a first diagram illustrating the slot count of the armature 2 according to the first embodiment. FIG. 10 is a second diagram illustrating the slot count of the armature 2 according to the first embodiment. Here, the method of counting slots is applied to the concentrated winding arrangement of the plurality of coils 7 and the distributed winding arrangement of the plurality of coils 7 is unified. FIG. 9 schematically illustrates an arrangement of the coils 7 in the case of concentrated winding. FIG. 10 schematically illustrates an arrangement of the coils 7 in the case of distributed winding. FIGS. 9 and 10 illustrate the regions where the coils 7 for U, V, and W phases are arranged. A mark in each of the regions indicates a direction of current flow through the coil 7. Identical marks indicate the same direction of current flow. Different marks indicate the opposite directions of current flow.

In the case of the concentrated winding illustrated in FIG. 9, coils 7 through which current flows in the opposite directions are disposed in two adjacent regions in the circumferential direction. In the case of the concentrated winding, each of these regions is defined as a slot. A region 13 illustrated in FIG. 9 is an example of the single slot.

In the case of the distributed winding illustrated in FIG. 10, regions with the same direction of current flow are adjacent to each other in the circumferential direction. For each phase, two regions where the current flows in the opposite directions are positioned with a plurality of regions between. In the case of the distributed winding, each of these regions is defined as a slot. A region 13 illustrated in FIG. 10 is an example of the single slot.

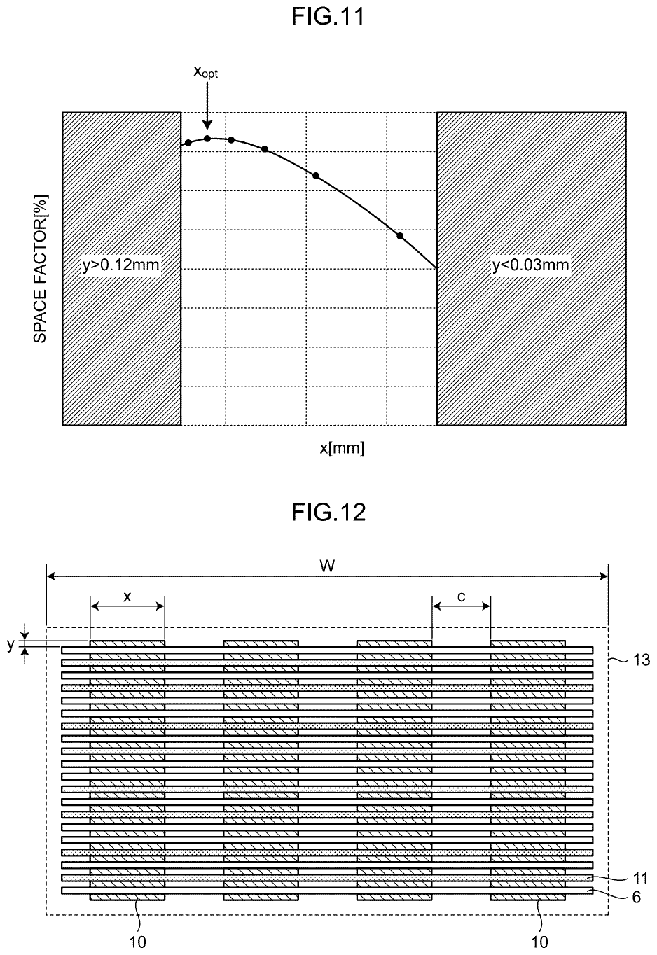

Next, a description is provided of a first method for determining the width x and the thickness y. FIG. 11 is a diagram illustrating an exemplary relationship between the width of the conductor 10 and a space factor of the conductors 10 in the slot in the armature 2 according to the first embodiment. FIG. 11 illustrates a graph showing the relationship between the width x of the conductor 10 and the space factor of the conductors 10. In FIG. 11, a vertical axis represents the space factor. A horizontal axis represents the width x of the conductor 10. Due to manufacturing constraints of the printed circuit board 5, the thickness y of the conductor 10 is limited to between 0.03 mm and 0.12 mm inclusive. The graph illustrated in FIG. 11 shows the relationship between the width x and the space factor when the thickness y ranges from 0.03 mm to 0.12 mm inclusive.

x and y are respectively set to xₒₚₜ and yₒₚₜ that, in combination, maximize the space factor of the conductors 10 in a cross section of the armature 2 that is perpendicular to the circumferential direction. In the graph illustrated in FIG. 11, xₒₚₜ refers to the x that maximizes the space factor. Since y is limited to between 0.03 mm and 0.12 mm inclusive, yₒₚₜ is limited to between 0.03 mm and 0.12 mm inclusive.

Here, a description is provided of details of theoretical formulas that show the relationship between the width x of the conductor 10 and the space factor of the conductors 10. The width x can be derived once the slot width W is determined. The slot width W is expressed by the following Formula (1) based on design specifications of the printed circuit board 5.

$$\begin{matrix}Formula 1 & \\ W = \frac{T}{fN} x + ( \frac{T}{fN} - 1 ) c & ( 1 )\end{matrix}$$

The slot width W is also expressed by the following Formula (2) based on various dimensions of the armature 2.

$$\begin{matrix}Formula 2 & \\ W = \frac{π ( D + d )}{2 n} - \frac{a}{2} & ( 2 )\end{matrix}$$

Combining Formulas (1) and (2) yields the following Formula (3), which expresses the width x.

$$\begin{matrix}Formula 3 & \\ x = \frac{fN}{T} \{ \frac{π ( D + d )}{2 n} - \frac{a}{2} - ( \frac{T}{fN} - 1 ) c \} & ( 3 )\end{matrix}$$

For the width a of the inner peripheral part, a=a is substituted into Formula (3) in the case of concentrated winding, while a=0 is substituted into Formula (3) in the case of distributed winding.

To obtain the width x of the conductor 10, the number of layers N of the armature 2 needs to be determined. The number of layers N can be obtained once the thickness y of the conductor 10 is determined. The thickness y is expressed by the following Formula (4).

$$\begin{matrix}Formula 4 & \\ y = \frac{D - d - 2 hN - 2 m ( N + 1 )}{2 fN} & ( 4 )\end{matrix}$$

As described above, due to the manufacturing constraints of the printed circuit board 5, the thickness y is limited to between 0.03 mm and 0.12 mm inclusive. The number of layers N is the positive integer. The number of layers N can be obtained by increasing or decreasing its value such that the value of y falls within the range from 0.03 mm to 0.12 mm inclusive. Once the thickness y and the number of layers N are determined, the width x can be obtained using Formula (3).

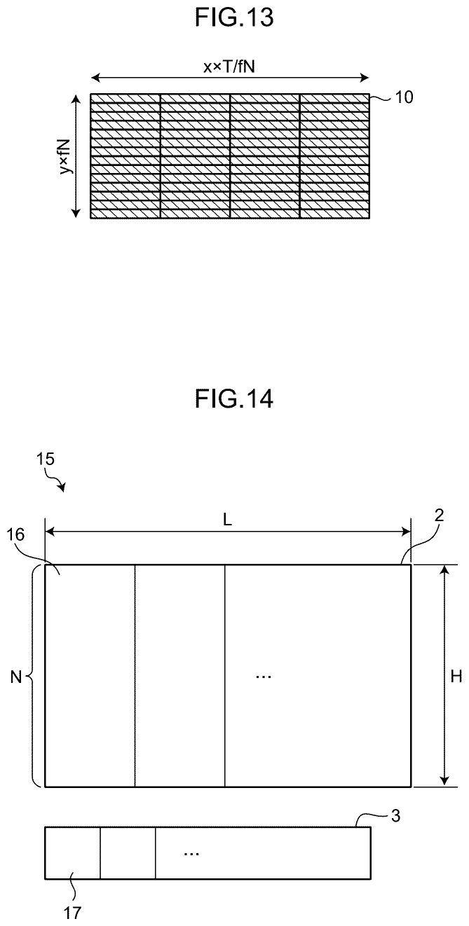

FIG. 12 is a cross-sectional view of the slot in the armature 2 according to the first embodiment. FIG. 13 is a diagram illustrating only cross sections of the conductors 10 that are extracted from the cross section illustrated in FIG. 12. FIG. 12 illustrates the cross section of the region 13, which is the single slot.

A cross-sectional area S of the conductors 10 in the slot is expressed by the following Formula (5). The cross-sectional area S can be derived once the width x and the thickness y are determined.

$$\begin{matrix}Formula 5 & \\ S = ( y \times fN ) \times ( x \times \frac{T}{fN} ) = xyT & ( 5 )\end{matrix}$$

Formulas (3) to (5) show that once the number of layers N is determined, the cross-sectional area S is determined.

The space factor of the conductors 10 in the slot is maximized by forming the printed circuit board 5 such that each conductor 10 has the width x and the thickness y that maximize the cross-sectional area S. The width x and the thickness y are respectively set to the width xₒₚₜ and the thickness yₒₚₜ, which, in combination, maximize the space factor of the conductors 10. Maximizing the space factor of the conductors 10 reduces electrical resistance and loss of the conductors 10. Accordingly, the electric motor 1 can reduce copper loss, thereby reducing heat generation from the copper loss.

The first method as a method for determining the width x and the thickness y has been described. Next, an alternative method for determining the width x and the thickness y is described as the second method. In the second example, the electric motor 1 is assumed to include one or more unit structures. Here, a set of a certain number of magnetic poles included in the field system 3 and a certain number of slots, which are the regions of the armature 2 where the coils 7 are arranged, is referred to as a unit structure of the electric motor 1.

FIG. 14 is a diagram illustrating the unit structure 15 of the electric motor 1 according to the first embodiment. FIG. 14 schematically illustrates a section of the armature 2 and a section of the field system 3 that form the single unit structure 15. In FIG. 14, a left-right direction corresponds to the circumferential direction, and an up-down direction corresponds to the radial direction. In the section of the armature 2 that is included in the single unit structure 15, the multiple slots are arranged in the circumferential direction. A rectangle 16 illustrated in FIG. 14 represents one of the multiple slots. In the section of the field system 3 that is included in the single unit structure 15, the multiple magnetic poles are arranged in the circumferential direction. A rectangle 17 illustrated in FIG. 14 represents one of the multiple magnetic poles.

For example, suppose that the electric motor 1 has a total of six magnetic poles and a total of nine slots. In this case, the unit structure 15 of the electric motor 1 is a set of two magnetic poles and three slots, and the electric motor 1 includes three such unit structures 15. It is to be noted that the unit structure 15 may include any number of magnetic poles and any number of slots. In addition, the electric motor 1 may include any number of unit structures 15. In the following description, the number of slots in the unit structure 15 is denoted by n′, the section of the armature 2 that is included in the unit structure 15 has a length of L in the circumferential direction, and the slots each have a length of H in the radial direction.

As in the first method, a combination of the width xₒₚₜ and the thickness yₒₚₜ is also derived in the second method once the slot width W is determined. In the second method as well, Formula (1) holds.

The slot width W is expressed by the following Formula (6) based on various dimensions of the armature 2.

$$\begin{matrix}Formula 6 & \\ W = \frac{L}{{n}^{′}} - \frac{a}{2} & ( 6 )\end{matrix}$$

Combining Formulas (1) and (6) yields the following Formula (7), which expresses the width x.

$$\begin{matrix}Formula 7 : & \\ x = \frac{fN}{T} \{ \frac{L}{{n}^{′}} - \frac{a}{2} - ( \frac{T}{fN} - 1 ) c \} & ( 7 )\end{matrix}$$

For the width a of the inner peripheral part, a=a is substituted into Formula (7) in the case of concentrated winding, while a=0 is substituted into Formula (7) in the case of distributed winding.

The thickness y is expressed by the following Formula (8).

$$\begin{matrix}Formula 8 : & \\ y = \frac{H - hN - m ( N + 1 )}{fN} & ( 8 )\end{matrix}$$

The number of layers N can be obtained by increasing or decreasing its value such that the value of y falls within the range from 0.03 mm to 0.12 mm inclusive. Once the thickness y and the number of layers N are determined, the width x can be obtained using Formula (7). The cross-sectional area S can be derived once the width x and the thickness y are determined.

The space factor of the conductors 10 in the slot is maximized by forming the printed circuit board 5 such that each conductor 10 has the width x and the thickness y that maximize the cross-sectional area S. The width x and the thickness y are respectively set to the width xₒₚₜ and the thickness yₒₚₜ, which, in combination, maximize the space factor of the conductors 10. Maximizing the space factor of the conductors 10 reduces the electrical resistance and the loss of the conductors 10. Accordingly, the electric motor 1 can reduce copper loss, thereby reducing heat generation from the copper loss.

### Second Embodiment

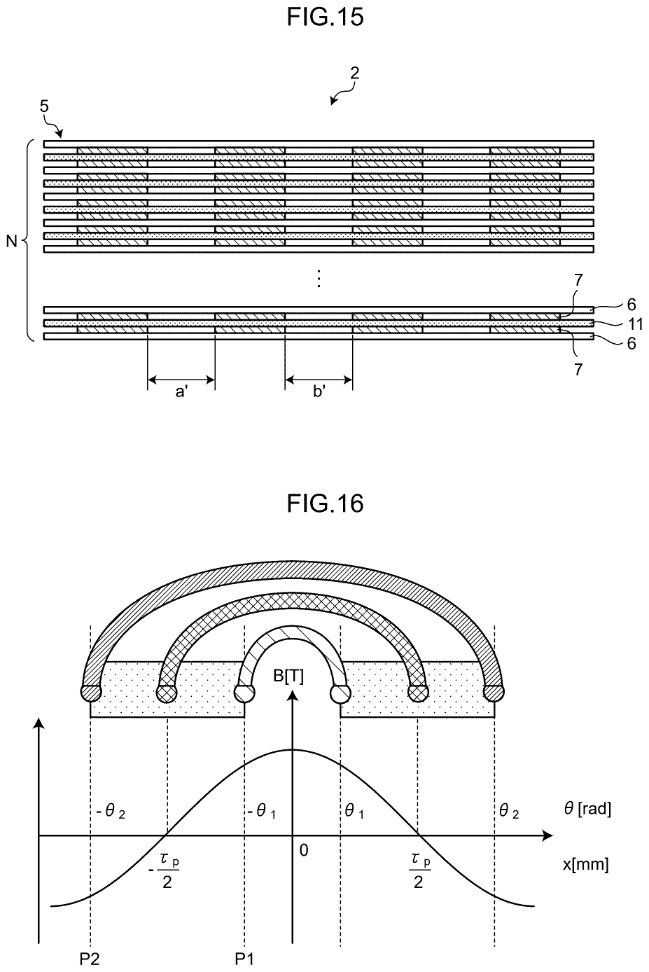

FIG. 15 is a sectional view of the armature 2 according to a second embodiment. In the second embodiment, a description is provided mainly of how its configuration differs from that of the first embodiment. FIG. 15 illustrates the cross section of a portion of a printed circuit board 5 that is rolled into a cylindrical shape. In FIG. 15, a left-right direction corresponds to the circumferential direction, and an up-down direction corresponds to the radial direction. The configuration illustrated in FIG. 15 is similar to the configuration illustrated in FIG. 5. A cross section of each region serving as a slot of the armature 2 is similar to the cross section illustrated in FIG. 6. In the second embodiment, a plurality of coils 7 are assumed to be in a concentrated winding arrangement.

In the configuration illustrated in FIG. 15, an inner peripheral part of each coil 7 has a width of a′, and a distance between adjacent coils 7 is denoted by b′. The width of the inner peripheral part is the width in the circumferential direction. The distance between the coils 7 is the distance in the circumferential direction. In the second embodiment, a′ and b′ are respectively set to a′ opt and b′ opt that, in combination, maximize a winding factor of the coil 7.

Copper loss that is generated in the electric motor 1 is known to be essentially in inverse proportion to the winding factor k_{w}. The winding factor k_{w} is a coefficient that is determined, for example, by a combination of a magnetic pole count and a slot count of the electric motor 1 or by an arrangement method of the plurality of coils 7 in the electric motor 1. The copper loss of the electric motor 1, which is a three-phase motor, is proportional to phase resistance Rp and the square of phase current. As the winding factor k_{w} increases, induced voltage of the electric motor 1 increases. Therefore, as the winding factor k_{w} increases, the phase current required to output the same torque decreases.

Here, a component proportional to the square of the reciprocal of the winding factor k_{w} is extracted, and the extracted component is referred to as a copper loss coefficient k_{Cu}. The copper loss coefficient k_{Cu} is expressed by the following Formula (9).

$$\begin{matrix}Fomula 9 : & \\ {k}_{Cu} = 3 \times {R}_{p} \times \frac{1}{{k}_{w}^{2}} & ( 9 )\end{matrix}$$

Furthermore, the winding factor k_{w} is known to be proportional to a short-pitch factor kₚ. The short-pitch factor kₚ is a coefficient that indicates a ratio by which flux linkage decreases when a slot pitch and a magnetic pole pitch differ. Although factors such as a distribution factor are also proportional to the winding factor k_{w} their details are omitted here.

FIG. 16 is a diagram illustrating a relationship between an arrangement of a coil 7 in the armature 2 according to the second embodiment and the winding factor.

In a graph illustrated in FIG. 16, a vertical axis represents the winding factor k_{w}, and a horizontal axis represents an electrical angle θ of the coil 7 and the width x of the conductor 10. A configuration of the coil 7 is schematically illustrated above the graph in FIG. 16.

The short-pitch factor kₚ of the electric motor 1, which includes the armature 2 illustrated in FIG. 15, can be derived from an amount of magnetic flux linked with the coil 7 at an inner peripheral position P1 of the coil 7 and at an outer peripheral position P2 of the coil 7. The inner peripheral position P1 refers to a point on an inner periphery of the coil 7 that adjoins the inner peripheral part. The outer peripheral position P2 refers to a point on an outer periphery of the coil 7. The amount of flux linkage in the coil 7 is small at the inner peripheral position P1 and at the outer peripheral position P2 and reaches its maximum at a midpoint between the inner peripheral position P1 and the outer peripheral position P2. A ratio between an amount of magnetic flux generated by a magnet and the amount of flux linkage corresponds to the short-pitch factor kₚ. Let φ_{magnet} be the amount of magnetic flux of each magnet. Let φ_{n_max} be the maximum value of the amount of flux linkage in each slot. Let θ₁ be an electrical angle at the inner peripheral position P1 of the coil 7 of each phase. Let θ₂ be an electrical angle at the outer peripheral position P2 of the coil 7 of each phase. The short-pitch factor kₚ is expressed by the following Formula (10).

$$\begin{matrix}Formula 10 : & \\ {k}_{p} = \frac{\frac{1}{n} {\int }_{1}^{n} {Φ}_{n , max} dn}{{Φ}_{magnet}} = \frac{( cos {θ}_{1} - cos {θ}_{2} )}{{θ}_{2} - {θ}_{1}} & ( 10 )\end{matrix}$$

The electrical angle θ₁ is expressed by the following formula (11) based on the configuration illustrated in FIG. 15. The electrical angle θ₂ is expressed by the following Formula (12) based on the configuration illustrated in FIG. 15. Let p be the number of magnetic poles applied to the electric motor 1, and let τₚ be the pitch at which the plurality of magnetic poles are arranged.

$$\begin{matrix}Formula 11 : & \\ {θ}_{1} = \frac{{a}^{′}}{2 {τ}_{p}} \times 180 & ( 11 )\end{matrix}$$

$$\begin{matrix}Formula 12 : & \\ {θ}_{2} = \frac{\frac{p}{n} {τ}_{p} - {b}^{′}}{2 {τ}_{p}} \times 180 & ( 12 )\end{matrix}$$

Formulas (9) to (12) show that the width a′ and the distance b′ are each related to the copper loss coefficient k_{cu}.

FIG. 17 is a diagram illustrating an exemplary relationship between the width of the inner peripheral part of each coil 7 and the copper loss coefficient in the electric motor 1 according to the second embodiment. A vertical axis of a graph illustrated in FIG. 17 represents the copper loss coefficient k_{cu}. A horizontal axis of the graph represents the width a′ of the inner peripheral part. The graph illustrated in FIG. 17 shows the relationship between the width a′ and the copper loss coefficient k_{cu} for cases where the distance b′ between adjacent coils 7 takes a value of 0, 1, 2, or 3.

According to FIG. 17, the smaller the value of the distance b′, the smaller the copper loss coefficient k_{cu}. A smaller copper loss coefficient k_{cu} indicates less copper loss. Furthermore, according to FIG. 17, even when the distance b′ takes any one of the values of 0, 1, 2, and 3, there exists a value of the width a′ that results in a local minimum of the copper loss coefficient k_{Cu}. The combination of the width a′ and the distance b′ for which the copper loss coefficient k_{Cu} reaches its local minimum corresponds to the combination of a′ opt and b′ opt that maximizes the winding factor k_{w} of the coil 7.

According to FIG. 17, as the width a′ approaches 0, an area of a portion of the coil 7 that faces the magnet increases, allowing the amount of flux linkage of the coil 7 to increase. As the amount of flux linkage of the coil 7 increases, the short-pitch factor kₚ increases, and the copper loss coefficient k_{Cu} decreases. When the width a′ increases to about τₚ/2, the coil 7 is no longer positioned where the magnet's magnetic flux density is at its maximum, causing a significant reduction in the short-pitch factor kₚ. Therefore, the width a′ opt preferably satisfies the following Formula (13).

$$\begin{matrix}Formula 13 : & \\ 0 < {a}_{opt}^{′} < \frac{{τ}_{p}}{2} & ( 13 )\end{matrix}$$

The above description of the width a′ₒₚₜ also holds true for the distance b′ₒₚₜ. Given a range of possible values of the electrical angle θ₂ in Formula (12), the distance b′ₒₚₜ preferably satisfies the following Formula (14).

$$\begin{matrix}Formula 14 : & \\ 0 < {b}_{opt}^{′} < ( \frac{p}{n} - \frac{1}{2} ) {τ}_{p} & ( 14 )\end{matrix}$$

The copper loss of the electric motor 1 is reduced when the plurality of coils 7 are formed to satisfy the width a′ opt and the distance b′ₒₚₜ that maximize the winding factor k_{w} of the coil 7. Furthermore, when the width a′ opt satisfies Formula (13) and when the distance b′ₒₚₜ satisfies Formula (14), the copper loss coefficient k_{Cu} can be reduced, resulting in a further reduction in the copper loss of the electric motor 1. Accordingly, the electric motor 1 can reduce the copper loss, thereby reducing heat generation from the copper loss.

### Third Embodiment

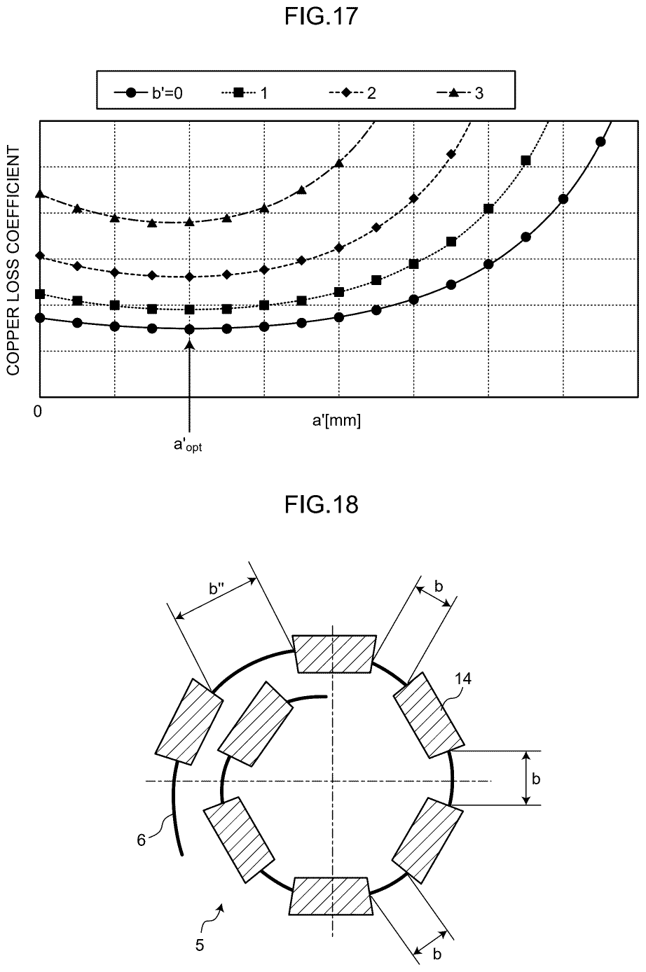

FIG. 18 is a first diagram illustrating a configuration of the armature 2 according to a third embodiment. FIG. 19 is a second diagram illustrating a configuration of the armature 2 according to the third embodiment. In the third embodiment, a description is provided mainly of how the configurations differ from that of the first or second embodiment.

FIGS. 18 and 19 each schematically illustrate how a printed circuit board 5 is rolled into a cylindrical shape from a flat state. In FIGS. 18 and 19, coil units 14 represent portions of the layers 12, each including two coils 7 stacked with the insulating layer 11 interposed between the two coils 7. Each coil unit 14 refers to an area of the layer 12 where the coils 7 are formed and can be said to be where a slot is formed. FIGS. 18 and 19 illustrate the core substrate 6 in simplified form. In FIGS. 18 and 19, the insulating layer 11 is omitted. In the third embodiment, the plurality of coils 7 are assumed to be in a concentrated winding arrangement.

The armature 2 with the N layers 12 is formed by rolling the printed circuit board 5 into the cylindrical shape. In the third embodiment, N is an integer greater than or equal to 2. For each slot of the armature 2, aligning multiple coil units 14 in the radial direction is preferable. However, if all the plurality of coils 7 on the core substrate 6 are arranged with a fixed distance b, positional offsets occur in the circumferential direction among the coil units 14 within each slot. The positional offsets among the coil units 14 cause the slot to have a shape different from an ideal shape. The ideal shape of the slot is the shape formed when the coils 7 from the layers 12 are aligned in the radial direction within the slot.

Here, M is an integer greater than or equal to 1 and less than N. Let b″ be a distance between coils 7 closest to a rolling end of the cylindrical shape in an M-th layer 12 counted from the central axis AX of the cylindrical shape among the plurality of layers 12 of the printed circuit board 5 and coils 7 closest to a rolling start of the cylindrical shape in an (M+1)-th layer 12 counted from the central axis AX of the cylindrical shape among the plurality of layers 12 of the printed circuit board 5. In FIGS. 18 and 19, a distance between a coil unit 14 closest to the rolling end of the cylindrical shape in the M-th layer 12 and a coil unit 14 closest to the rolling start of the cylindrical shape in the (M+1)-th layer 12 is denoted by b″. If the distance b″ is the same length as the distance b between the coils 7 in each of the plurality of layers 12 of the printed circuit board 5, theoretically, the coils 7 in the (M+1)-th layer 12 will be offset in the circumferential direction relative to the coils 7 in the M-th layer 12.

In the third embodiment, as illustrated in FIG. 18, positions of the coils 7 on the core substrate 6 are determined such that the distance b″ is greater than the distance b. By making the distance b″ greater than the distance b, the positional offset of the coils 7 in the (M+1)-th layer 12 relative to the coils 7 in the M-th layer 12 can be eliminated. In other words, the coils 7 in the (M+1)-th layer 12 can be aligned in the radial direction with the coils 7 in the M-th layer 12. FIG. 19 illustrates how coil units 14 in the (M+1)-th layer 12 are aligned in the radial direction with coil units 14 in the M-th layer 12 by bending a portion of the core substrate 6 that corresponds to the distance b″, starting from the state illustrated in FIG. 18. By making the distance b″ greater than the distance b and adjusting circumferential positions of the coil units 14 thus, the coil units 14 in the one layer 12 can be aligned in the radial direction with the coil units 14 in the layer 12 on an outer peripheral side of that layer 12. Aligning the coil units 14 in the radial direction across the radially adjacent layers 12 enables each slot to have the ideal shape.

In the third embodiment, the distance b″ satisfies the following Formula (15).

$$Formula 15 :$$

$$b \leq {b}^{″} < \sqrt{\begin{matrix}{b}^{2} + {( h + yf + 2 m )}^{2} - 2 b ( h + yf + 2 m ) \\ cos ( \frac{( 2 - n ) π}{2 n} - \frac{NW}{MD + d \{ N - ( M - \frac{1}{2} ) \}}\end{matrix}} \qquad ( 15 )$$

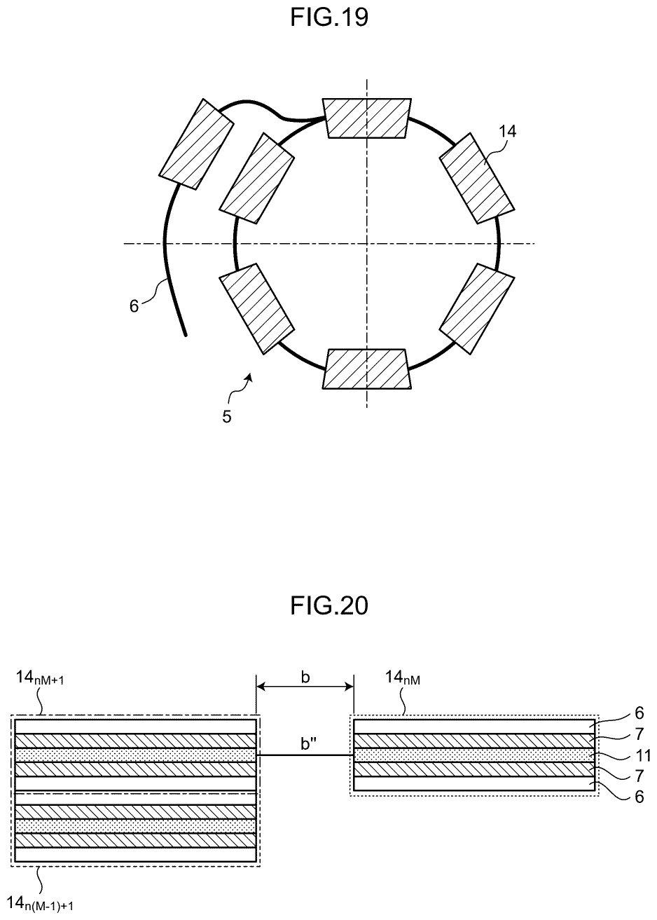

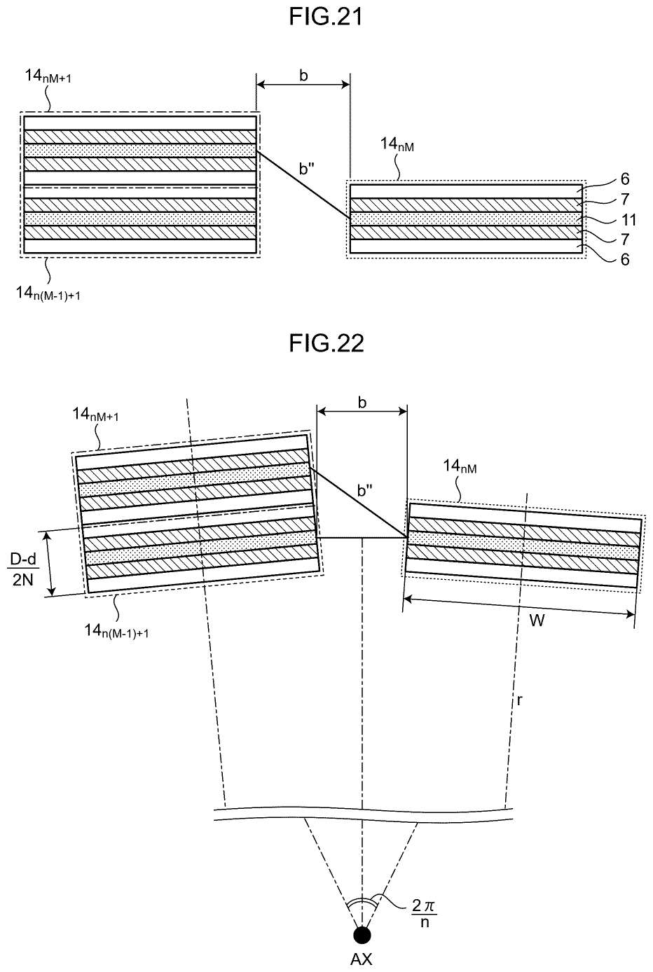

Here, a description is provided of how Formula (15) is derived. FIG. 20 is a first diagram illustrating an arrangement of the coils 7 in the armature 2 according to the third embodiment. FIG. 21 is a second diagram illustrating an arrangement of the coils 7 in the armature 2 according to the third embodiment.

In FIGS. 20 and 21, a coil unit 14_{nM} is the nM-th coil unit 14 counted from the rolling start of the printed circuit board 5. The coil unit 14_{nM} refers to the coil unit 14 closest to the rolling end of the cylindrical shape in the M-th layer 12. A coil unit 14_{nM+1} is the (nM+1)-th coil unit 14 counted from the rolling start of the printed circuit board 5. The coil unit 14_{nM} refers to the coil unit 14 closest to the rolling start of the cylindrical shape in the (M+1)-th layer 12. A coil unit 14_{n(M-1)+1} is the {n(M−1)+1}-th coil unit 14 counted from the rolling start of the printed circuit board 5. The coil unit 14_{n(M-1)+1} is the coil unit 14 closest to the rolling start of the cylindrical shape in an (M−1)-th layer 12.

FIG. 20 illustrates a case where the distance b″ satisfies Formula (15) and is at its shortest, meaning that the distance b″ is the same length as the distance b. In this case, the coil units 14_{nM+1} and 14_{nM} are arranged on the same circle centered on the central axis AX. The above theoretical description states that if the distance b″ is the same length as the distance b, the coils 7 in the (M+1)-th layer 12 will be offset in the circumferential direction relative to the coils 7 in the M-th layer 12. However, when the printed circuit board 5 is rolled into the cylindrical shape, the cylindrical shape may bulge in the radial direction, or the printed circuit board 5 may deform due to tension applied to the printed circuit board 5. Even when the distance b″ is the same length as the distance b, the coils 7 in the (M+1)-th layer 12 could still be aligned in the radial direction with the coils 7 in the M-th layer 12 due to bulging of the cylindrical shape or deformation of the printed circuit board 5. Therefore, Formula (15) includes the case where the distance b″ is equal to the distance b.

FIG. 21 illustrates a case where the distance b″ satisfies Formula (15) and is at its longest.

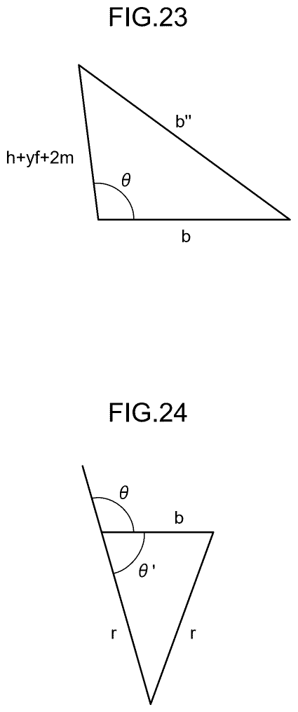

FIG. 22 is a third diagram illustrating the arrangement of the coils 7 in the armature 2 according to the third embodiment. FIG. 23 is a fourth diagram illustrating the arrangement of the coils 7 in the armature 2 according to the third embodiment. FIG. 24 is a fifth diagram illustrating the arrangement of the coils 7 in the armature 2 according to the third embodiment.

FIG. 22 schematically illustrates the arrangement of the coil units 14_{n(M-1)+1}, 14_{nM}, and 14_{nM+1} in the armature 2 when the distance b″ is at its longest. An expression on a right side of “<” in Formula (15) represents the case where the coil units 14_{n(M-1)+1} and 14_{nM} are arranged on the same circle centered on the central axis AX.

A triangle illustrated in FIG. 23 represents a triangle defined by the coil units 14_{n(M-1)+1}, 14_{hM+1}, and 14_{nM} in FIG. 22. The triangle illustrated in FIG. 23 includes a first side having a length equal to the distance b″, a second side having a length equal to the distance b, and a third side having a length of h+yf+2m. In FIG. 23, an angle θ is the angle formed by the second side and the third side, that is, the angle opposite the first side.

The distance b″ is expressed by the following Formula (16).

$$\begin{matrix}Formula 16 : & \\ {b}^{″} = \sqrt{{b}^{2} + {( h + yf + 2 m )}^{2} - 2 b ( h + yf + 2 m ) cos θ} & ( 16 )\end{matrix}$$

A radius r is the radius of the circle on which the coil units 14_{n(M-1)+1} and 14 mm are arranged and which is centered on the central axis AX. An angle θ′ illustrated in FIG. 24 is the angle that appears when the third side of the triangle illustrated in FIG. 23 is extended toward the central axis AX. The angle θ′ is a supplementary angle to the angle between the second and third sides. The angle θ′ is expressed by the following Formula (17).

$$\begin{matrix}Formula 17 : & \\ {θ}^{′} = π - θ & ( 17 )\end{matrix}$$

An angle formed between a straight line passing through the central axis AX and a circumferential center of the coil unit 14_{n(M-1)+1} and a straight line passing through the central axis AX and a circumferential center of the coil unit 14_{nM} is expressed as 2_{π/n}. The width of the coil unit 14, namely the slot width W, can be expressed using the radius r. Accordingly, the angle θ′ is expressed by the following Formula (18).

$$\begin{matrix}Formula 18 : & \\ {θ}^{′} = \frac{π}{2} - \frac{1}{2} ( \frac{2 π}{n} - \frac{W}{r} ) & ( 18 )\end{matrix}$$

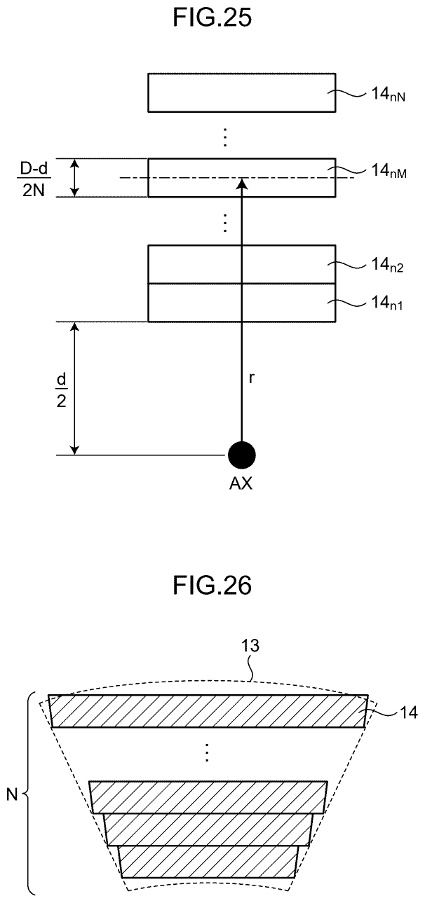

FIG. 25 is a sixth diagram illustrating an arrangement of coils 7 in the armature 2 according to the third embodiment. FIG. 25 illustrates the N coil units 14ₙ₁, 14ₙ₂, . . . , 14_{nM}, . . . , and 14_{nN} that form one of the slots. The coil unit 14ₙ₁ is the coil unit 14 in the first layer 12. The coil unit 14ₙ₂ is the coil unit 14 in the second layer 12. The coil unit 14_{nM} is the coil unit 14 in the M-th layer 12. The coil unit 14_{nN} is the coil unit 14 in the N-th layer 12. A radial length of a single layer 12 is expressed as (D−d)/2N. The radius r is expressed by the following Formula (19).

$$\begin{matrix}Formula 19 : & \\ r = \frac{d}{2} + \frac{D - d}{2 N} ( M - \frac{1}{2} ) & ( 19 )\end{matrix}$$

Substituting Formulas (17) to (19) into Formula (16) yields the expression on the right side of “<” in Formula (15). However, rolling the printed circuit board 5 into the cylindrical shape can be said not to result in an assumed situation where the distance b″ equals the expression on the right side of “<” in Formula (15) because of the bulging of the cylindrical shape or the deformation of the printed circuit board 5. Therefore, Formula (15) excludes the case where the distance b″ equals the expression on the right side of “<” in Formula (15).

In the third embodiment, when the distance b″ satisfies Formula (15), the coil units 14 can be aligned in the radial direction across the radially adjacent layers 12. This enables each slot in the armature 2 to have the ideal shape.

### Fourth Embodiment

FIG. 26 is a cross-sectional view of a portion of the armature 2 according to a fourth embodiment. FIG. 26 illustrates the cross section of the region 13, which is an example of a single slot. In the fourth embodiment, a description is provided mainly of how its configuration differs from those of the first through third embodiments. The cross section illustrated in FIG. 26 is the section perpendicular to the central axis AX. FIG. 26 illustrates N coil units 14. In the fourth embodiment, N is an integer greater than or equal to 2.

A nearly trapezoidal shape is an ideal shape for the slot in the cross section illustrated in FIG. 26 when the armature 2 is manufactured. In the fourth embodiment, each of the coil units 14 is longer in the circumferential direction on an outer peripheral side of the cylindrical shape than on an inner peripheral side of the cylindrical shape, thus shaping the slot closer to the ideal shape.

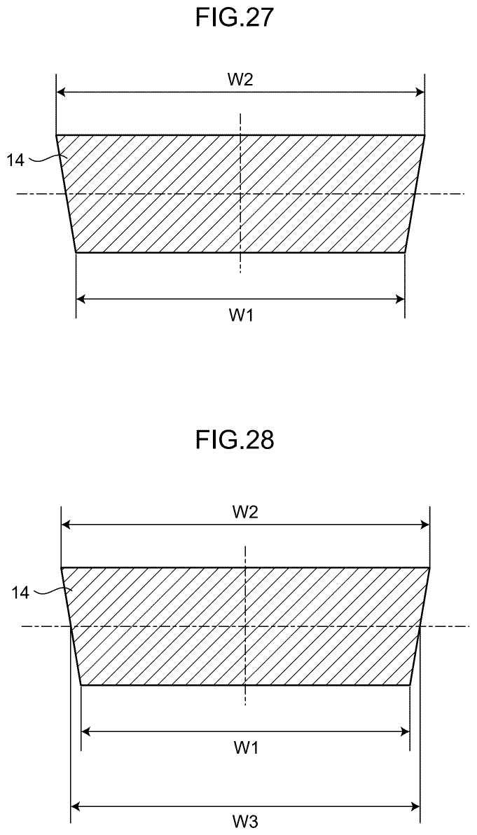

FIG. 27 is a cross-sectional view of the coil unit 14 in the armature 2 according to the fourth embodiment. The cross section illustrated in FIG. 27 is the section perpendicular to the central axis AX.

Let W1 be a circumferential width of an end of the coil unit 14 (i.e., the area of the layer 12 where the coils 7 are formed) that is closer to the central axis AX, and let W2 be a circumferential width of an opposite end of the coil unit 14 with respect to the central axis AX. W1 and W2 satisfy the following Formula (20).

$$\begin{matrix}Formula 20 : & \\ 1 < \frac{W 2}{W 1} < 1.05 & ( 20 )\end{matrix}$$

In each of the coil units 14 forming the slot, the width W2 is about 0% to 5% greater than the width W1. This enables the slot to have the ideal shape, which is nearly trapezoidal. Forming the slot into the ideal shape can reduce deformation of the armature 2 during the manufacture of the armature 2.

### Fifth Embodiment

FIG. 28 is a cross-sectional view of a coil unit 14 in the armature 2 according to a fifth embodiment. The cross section illustrated in FIG. 28 is the section perpendicular to the central axis AX. In the fifth embodiment, a description is provided mainly of how its configuration differs from those of the first through fourth embodiments.

Let W1 be a circumferential width of an end of the coil unit 14 (i.e., the area of the layer 12 where the coils 7 are formed) that is closer to the central axis AX, let W2 be a circumferential width of an opposite end of the coil unit 14 with respect to the central axis AX, and let W3 be a circumferential width measured at a radial center of the coil unit 14. W1 and W3 satisfy the following Formula (21). W2 and W3 satisfy the following Formula (22).

$$\begin{matrix}Formula 21 : & \\ 1 < \frac{W 3}{W 1} < 1.025 & ( 21 )\end{matrix}$$

$$\begin{matrix}Formula 22 : & \\ 1 < \frac{W 2}{W 3} < 1.025 & ( 22 )\end{matrix}$$

The width W3 can be said to be the representative circumferential width of the coil unit 14. The width W1 is smaller than the representative width W3, and the width W2 is greater than the representative width W3. This enables a slot to have an ideal shape that is nearly trapezoidal. Forming the slot into the ideal shape can reduce deformation of the armature 2 during the manufacture of the armature 2.

### Sixth Embodiment

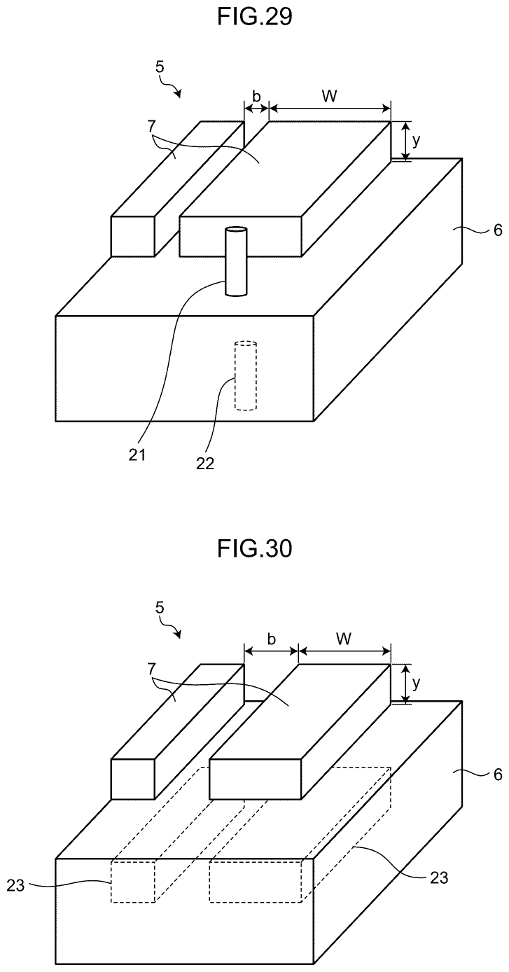

FIG. 29 is a schematic diagram of a printed circuit board 5 included in the armature 2 according to a sixth embodiment. In the sixth embodiment, a description is provided mainly of how its configuration differs from those of the first through fifth embodiments. In the sixth embodiment, pins 21 are provided on one face of a core substrate 6, standing upright in the radial direction. The core substrate 6 includes holes 22 formed on an opposite face. Each of the holes 22 is shaped to fit the pin 21. FIG. 29 illustrates a portion of the core substrate 6 where two of the coils 7, one of the pins 21, and one of the holes 22 are provided. The pins 21 and the holes 22 are each provided in an area of the core substrate 6 other than areas where the coils 7 are formed.

If errors in the alignment of the coils 7, which form slots, can be reduced when the printed circuit board 5 is rolled into a cylindrical shape, the slots can be brought closer to their ideal shape. In the sixth embodiment, the pins 21 are fitted into the holes 22 when the printed circuit board 5 is rolled to form the plurality of stacked layers 12. Relative positions of the pins 21 and the holes 22 are set such that each pin 21 can be fitted into the corresponding hole 22 when the printed circuit board 5 is rolled to form the plurality of stacked layers 12. In the core substrate 6, the areas are allocated for the pins 21 and the holes 22 at axial positions relative to the areas where the coils 7 are formed. This prevents the printed circuit board 5 from becoming longer in the circumferential direction and enables the pins 21 and the holes 22 to be provided without reducing a space factor.

A radial length of the pin 21 is greater than the thickness y of the coil 7. A radial depth of the hole 22 is greater than a difference between the radial length of the pin 21 and the thickness y. The pin 21 is not limited to a columnar shape illustrated in FIG. 29. The pin 21 may have any shape that can reduce the errors in the alignment of the coils 7, such as an elliptical cylinder that is long in the axial or circumferential direction. The hole 22 is shaped in accordance with the shape of the pin 21. Each pin 21 and the corresponding hole 22 may be in any relative position that allows for the reduction of errors in the alignment of the coils 7. The position of the hole 22 may be offset in the axial or circumferential direction relative to the position of the pin 21.

The pins 21 are formed of any material. The pins 21 may be formed of the same material as one of the components of the printed circuit board 5 or may be formed of a material not used for any component of the printed circuit board 5. The pins 21 may be joined when the components of the printed circuit board 5 are installed or may be added after the components of the printed circuit board 5 are installed.

During the manufacture of the armature 2, the pins 21 are fitted into the holes 22, thereby reducing errors in the alignment of the coils 7, which form the slots. In this way, performance deterioration of the electric motor 1 can be prevented.

### Seventh Embodiment

FIG. 30 is a schematic diagram of a printed circuit board 5 included in the armature 2 according to a seventh embodiment. In the seventh embodiment, a description is provided mainly of how its configuration differs from those of the first through sixth embodiments. In the seventh embodiment, the plurality of coils 7 are provided on one face of a core substrate 6. The core substrate 6 includes, on an opposite face, recesses 23 that are each shaped to fit the corresponding coil 7. FIG. 30 illustrates a portion of the core substrate 6 where two of the coils 7 and two of the recesses 23 are provided.

In the seventh embodiment, the coils 7 are fitted into the recesses 23 when the printed circuit board 5 is rolled to form the plurality of stacked layers 12. Each recess 23 is shaped in accordance with the shape of the coil 7. A position of each recess 23 is set such that the corresponding coil 7 can be fitted into the recess 23 when the printed circuit board 5 is rolled to form the plurality of stacked layers 12.

During the manufacture of the armature 2, the coils 7 are fitted into the recesses 23, thereby reducing errors in the alignment of the coils 7, which form slots. In this way, performance deterioration of the electric motor 1 can be prevented. In the seventh embodiment, the core substrate 6 has larger areas of contact with the coils 7 than in the sixth embodiment. For this reason, in the seventh embodiment, a coefficient of heat transfer between the stacked layers 12 is improved compared to the sixth embodiment. With the improved coefficient of heat transfer between the stacked layers 12, the electric motor 1 allows for a reduction in temperature rise of the coils 7 during energization.

### Eighth Embodiment

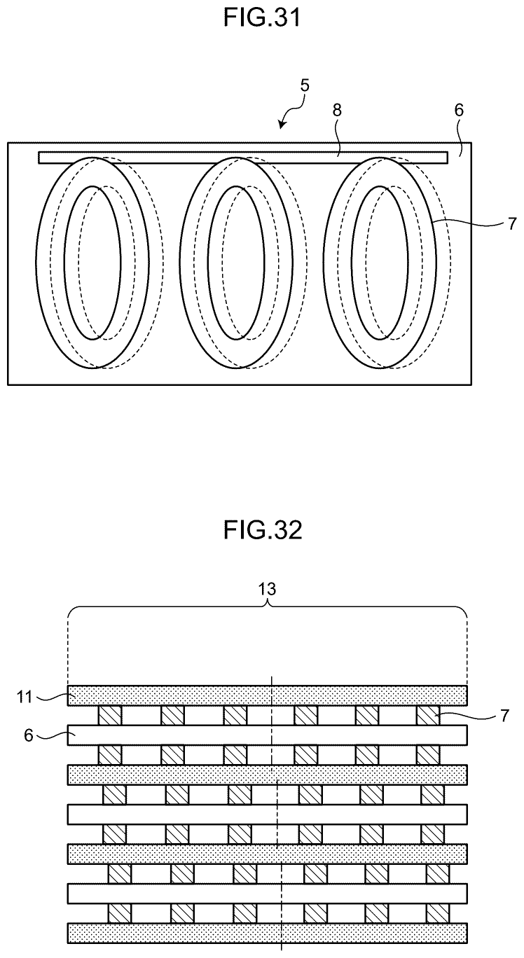

FIG. 31 is a diagram illustrating a schematic configuration of a printed circuit board 5 included in the armature 2 according to an eighth embodiment. In the eighth embodiment, a description is provided mainly of how its configuration differs from those of the first through seventh embodiments. FIG. 31 illustrates a portion of the printed circuit board 5 unrolled flat from its cylindrical shape.

In the eighth embodiment, circumferential positions of the coils 7 are offset for each layer 12 across the plurality of layers 12. With this configuration, electrical angles of radially adjacent coils 7 differ. FIG. 31 illustrates the coils 7 provided in one of the layers 12. In FIG. 31, for reference, the coils 7 of a layer 12 disposed behind that layer 12 in a depth direction of a paper surface are shown in broken lines.

FIG. 32 is a cross-sectional view of a portion of the armature 2 according to the eighth embodiment. FIG. 32 illustrates the cross section of the region 13, which is an example of a single slot. The cross section illustrated in FIG. 32 is the section perpendicular to the central axis AX. In FIG. 32, a left-right direction corresponds to the circumferential direction, and an up-down direction corresponds to the axial direction. As illustrated in FIG. 32, the circumferential positions of the coils 7 are offset on the basis of their radial locations. The plurality of coils 7 are mounted on the printed circuit board 5 such that the circumferential positions of the coils 7 are offset on the basis of their radial locations.

Offsetting the circumferential positions of the coils 7 for each layer 12 enables formation of the armature 2 with a so-called skew. This enables the electric motor 1 to reduce torque ripple or thrust ripple in a driving direction of the electric motor 1.

The above configurations illustrated in the embodiments are illustrative of contents of the present disclosure. The configurations of the embodiments can be combined with other techniques that are publicly known. The configurations of the embodiments may be combined with each other as appropriate. The configurations of the embodiments can be partly omitted or changed without departing from the gist of the present disclosure.

### REFERENCE SIGNS LIST

1 electric motor; 2 armature; 3 field system; 4 shaft; 5 printed circuit board; 6 core substrate; 7 coil; 8 crossover wiring; 9 space; 10 conductor; 11 insulating layer; 12 layer; 13 region; 14, 14ₙ₁, 14ₙ₂, 14_{n(M-1)+1}, 14_{nM}, 14_{nM+1}, 14_{nN} coil unit; 15 unit structure; 16, 17 rectangle; 21 pin; 22 hole; 23 recess; AX central axis.

1. An electric motor comprising:
an armature including a printed circuit board having a cylindrical shape, the printed circuit board forming a plurality of layers stacked in a radial direction of the cylindrical shape; and
a field system disposed toward a central axis of the cylindrical shape with respect to the armature, wherein
the printed circuit board includes a plurality of coils arranged in a circumferential direction of the cylindrical shape,
each of the plurality of coils is formed from a linear conductor,
the conductor on the printed circuit board has a width denoted by x and a thickness in the radial direction denoted by y,
for the layers stacked in the radial direction in the armature, a number of layers is determined such that the y is limited to a predetermined range of values,
in a cross section of each of slots that are regions of the armature where the coils are arranged, the conductors have a cross-sectional area denoted by S, the cross section being perpendicular to the circumferential direction, and
in the armature where the determined number of layers are stacked, the x and the y are respectively set to xₒₚₜ and yₒₚₜ that, in combination, maximize the S in value.

2. The electric motor according to claim 1, wherein
the printed circuit board further includes a core substrate on which the plurality of coils are formed and an insulating layer provided between coils across the plurality of layers,
the xₒₚₜ satisfies formula (1), as follows:
$$\begin{matrix}Formula 1 : & \\ {x}_{opt} = \frac{fN}{T} \{ \frac{π ( D + d )}{2 n} - \frac{a}{2} - ( \frac{T}{fN} - 1 ) c \} , & ( 1 )\end{matrix}$$
and
the yₒₚₜ satisfies formula (2), as follows:
$$\begin{matrix}Formula 2 & \\ {y}_{opt} = \frac{D - d - 2 h N - 2 m ( N + 1 )}{2 f N} , & ( 2 )\end{matrix}$$
wherein c is a spacing between linear portions of the conductor in the coil on the printed circuit board, f is a number of conductors per slot formed in each of the layers of the printed circuit board, h is a thickness of the core substrate in the radial direction, m is a thickness of the insulating layer in the radial direction, n is a number of slots that are regions of the armature where the coils are arranged, T is a number of coil turns per slot, N is a number of radially stacked layers of the printed circuit board in the armature, D is an outside diameter of the armature, d is an inside diameter of the armature, and a is a width in the circumferential direction of an inner peripheral part serving as a central space of the coil.

3. The electric motor according to claim 1, wherein
the electric motor includes one or more unit structures, each of the unit structures being a set of a certain number of magnetic poles included in the field system and a certain number of slots, the slots being regions of the armature where the coils are arranged,
the printed circuit board further includes a core substrate where the plurality of coils are formed and an insulating layer provided between coils across the plurality of layers,
the xₒₚₜ satisfies formula (3), as follows:
$$\begin{matrix}Formula 3 & \\ {x}_{opt} = \frac{fN}{T} \{ \frac{L}{{n}^{′}} - \frac{a}{2} - ( \frac{T}{fN} - 1 ) c \} , & ( 3 )\end{matrix}$$
and
the yₒₚₜ satisfies formula (4), as follows:
$$\begin{matrix}Formula 4 & \\ {y}_{opt} = \frac{H - hN - m ( N + 1 )}{fN} & ( 4 )\end{matrix}$$
wherein c is a spacing between linear portions of the conductors in the coil on the printed circuit board, f is a number of conductors per slot formed in each of the layers of the printed circuit board, h is a thickness of the core substrate in the radial direction, m is a thickness of the insulating layer in the radial direction, n′ is the number of slots in the unit structure, T is a number of coil turns per slot, Nis a number of radially stacked layers of the printed circuit board in the armature, L is a circumferential length of a section of the armature that is included in the unit structure, H is a radial length of each of the slots, and a is a width in the circumferential direction of an inner peripheral part serving as a central space of the coil.

4. The electric motor according to claim 1, wherein
the yₒₚₜ is a thickness limited to between 0.03 mm and 0.12 mm inclusive.

5. The electric motor according to claim 2, wherein
the plurality of coils are in a concentrated winding arrangement,
the inner peripheral part serving as the central space of the coil has a width in the circumferential direction denoted by a′, a distance between adjacent coils is denoted by b′, and
the a′ and the b′ are respectively set to a′ₒₚₜ and b′ₒₚₜ that, in combination, maximize a winding factor of the coil.

6. The electric motor according to claim 5, wherein
the a′ₒₚₜ satisfies formula (5), as follows:
$$\begin{matrix}Formula 5 & \\ 0 < {a}_{opt}^{′} < \frac{{τ}_{p}}{2} , & ( 5 )\end{matrix}$$
and
the b′ₒₚₜ satisfies formula (6), as follows:
$$\begin{matrix}Formula 6 & \\ 0 < {b}_{opt}^{′} < ( \frac{p}{n} - \frac{1}{2} ) {τ}_{p} & ( 6 )\end{matrix}$$
wherein p is a number of magnetic poles applied to the electric motor, and τₚ is a pitch for arranging the plurality of magnetic poles.

7. The electric motor according to claim 2, wherein
the plurality of coils are in a concentrated winding arrangement, and
b″ satisfies formula (7), as follows:
$$\begin{matrix}Formula 7 & \\ h \leq {b}^{″} < \sqrt{{b}^{2} + {( h + yf + 2 m )}^{2} - 2 b ( h + yf + 2 m ) cos ( \frac{( 2 - n ) π}{2 n} - \frac{NW}{MD + d \{ N - ( M - \frac{1}{2} ) \}} )} , & ( 7 )\end{matrix}$$
wherein M is an integer greater than or equal to 1 and less than the N, the b″ is a distance between coils closest to a rolling end of the cylindrical shape in an M-th layer counted from the central axis of the cylindrical shape among the plurality of layers of the printed circuit board and coils closest to a rolling start of the cylindrical shape in an M+1-th layer counted from the central axis of the cylindrical shape among the plurality of layers of the printed circuit board, b is a distance between the coils in each of the plurality of layers of the printed circuit board, and W is a width in the circumferential direction of each of the slots.

8. The electric motor according to claim 7, wherein
W1 and W2 satisfy formula (8), as follows:
$$\begin{matrix}Formula 8 & \\ 1 < \frac{W 2}{W 1} < 1.05 , & ( 8 )\end{matrix}$$
wherein the W1 is a c width in the circumferential direction of an end of a coil unit that is closer to the central axis, and the W2 is a width in the circumferential direction of an opposite end of the coil unit with respect to the central axis, the coil unit being a coil-forming area of each of the layers.

9. The electric motor according to claim 7, wherein
the W1 and the W3 satisfy formula (9), as follows:
$$\begin{matrix}Formula 9 & \\ 1 < \frac{W 3}{W 1} < 1.025 , & ( 9 )\end{matrix}$$
and
the W2 and the W3 satisfy formula (10), as follows:
$$\begin{matrix}Formula 10 & \\ 1 < \frac{W 2}{W 3} < 1.025 , & ( 10 )\end{matrix}$$
wherein the W1 is a width in the circumferential direction of an end of a coil unit that is closer to the central axis, the W2 is a width in the circumferential direction of an opposite end of the coil unit with respect to the central axis, and the W3 is a width in the circumferential direction measured at a radial center of the coil unit, the coil unit being a coil-forming area of each of the layers.

10. The electric motor according to claim 1, wherein
the printed circuit board further includes the core substrate where the plurality of coils are formed,
pins are provided on one face of the core substrate, standing upright in the radial direction, and
holes are formed on an opposite face of the core substrate and are shaped to fit the pins.

11. The electric motor according to claim 1, wherein
the printed circuit board further includes the core substrate where the plurality of coils are formed,
the plurality of coils are provided on one face of the core substrate, and
recesses are formed on an opposite face of the core substrate and are shaped to fit the coils.

12. The electric motor according to claim 1, wherein
circumferential positions of the coils are offset for each of the layers across the plurality of layers.

13. The electric motor according to claim 3, wherein
the plurality of coils are in a concentrated winding arrangement,
the inner peripheral part serving as the central space of the coil has a width in the circumferential direction denoted by a′, a distance between adjacent coils is denoted by b′, and
the a′ and the b′ are respectively set to a′ₒₚₜ and b′ₒₚₜ that, in combination, maximize a winding factor of the coil.

14. The electric motor according to claim 13, wherein
the a′ₒₚₜ satisfies formula (5), as follows:
$$\begin{matrix}Formula 5 & \\ 0 < {a}_{opt}^{′} < \frac{{τ}_{p}}{2} , & ( 5 )\end{matrix}$$
and
the b′ₒₚₜ satisfies formula (6), as follows:
$$\begin{matrix}Formula 6 & \\ 0 < {b}_{opt}^{′} < ( \frac{p}{n} - \frac{1}{2} ) {τ}_{p} & ( 6 )\end{matrix}$$
wherein p is a number of magnetic poles applied to the electric motor, and τₚ is a pitch for arranging the plurality of magnetic poles.

15. The electric motor according to claim 3, wherein
the plurality of coils are in a concentrated winding arrangement, and
b″ satisfies formula (7), as follows:
$$\begin{matrix}Formula 7 & \\ h \leq {b}^{″} < \sqrt{{b}^{2} + {( h + yf + 2 m )}^{2} - 2 b ( h + yf + 2 m ) cos ( \frac{( 2 - n ) π}{2 n} - \frac{NW}{MD + d \{ N - ( M - \frac{1}{2} ) \}} )} , & ( 7 )\end{matrix}$$
wherein M is an integer greater than or equal to 1 and less than the N, the b″ is a distance between coils closest to a rolling end of the cylindrical shape in an M-th layer counted from the central axis of the cylindrical shape among the plurality of layers of the printed circuit board and coils closest to a rolling start of the cylindrical shape in an M+1-th layer counted from the central axis of the cylindrical shape among the plurality of layers of the printed circuit board, b is a distance between the coils in each of the plurality of layers of the printed circuit board, and W is a width in the circumferential direction of each of the slots.

16. The electric motor according to claim 15, wherein
W1 and W2 satisfy formula (8), as follows:
$$\begin{matrix}Formula 8 & \\ 1 < \frac{W 2}{W 1} < 1.05 , & ( 8 )\end{matrix}$$
wherein the W1 is a c width in the circumferential direction of an end of a coil unit that is closer to the central axis, and the W2 is a width in the circumferential direction of an opposite end of the coil unit with respect to the central axis, the coil unit being a coil-forming area of each of the layers.

17. The electric motor according to claim 15, wherein
the W1 and the W3 satisfy formula (9), as follows:
$$\begin{matrix}Formula 9 & \\ 1 < \frac{W 3}{W 1} < 1.025 , & ( 9 )\end{matrix}$$
and
the W2 and the W3 satisfy formula (10), as follows:
$$\begin{matrix}Formula 10 & \\ 1 < \frac{W 2}{W 3} < 1.025 , & ( 10 )\end{matrix}$$
wherein the W1 is a width in the circumferential direction of an end of a coil unit that is closer to the central axis, the W2 is a width in the circumferential direction of an opposite end of the coil unit with respect to the central axis, and the W3 is a width in the circumferential direction measured at a radial center of the coil unit, the coil unit being a coil-forming area of each of the layers.
